(19) United States
(12) Patent Application Publication
(10) Pub. No.: US 2007/0075622 A1
(43) Pub. Date: Apr. 5, 2007

(54) Anode structure for field emission display

(75) Inventors: Cai-Lin Guo, Bei-Jing (CN); Li Qian, Bei-Jing (CN); Jie Tang, Bei-Jing (CN); Liang Liu, Bei-Jing (CN); Bing-Chu Du, Bei-Jing (CN); Zhao-Fu Hu, Bei-Jing (CN); Pi-Jin Chen, Bei-Jing (CN); Shou-Shan Fan, Bei-Jing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: Tsinghua University, Beijing (CN); HON HAI PRECISION INDUSTRY CO., LTD., Tu-Cheng (TW)

(21) Appl. No.: 11/309,334

(22) Filed: Jul. 27, 2006

(30) Foreign Application Priority Data
Aug. 26, 2005 (CN) 200510036895.5

(51) Int. Cl. H01J 63/04; H01J 1/62

(52) U.S. Cl. 313/496

(57) ABSTRACT

An anode structure (110) for a field emission display (100) includes a front substrate (111), an anode electrode (112) formed on the front substrate, a phosphor layer (113) formed on the anode electrode and a getter material (114). The phosphor layer has a plurality of separated phosphor strips (1131, 1132, 1133) each configured for emitting light of a respective single color. The getter material is arranged between adjacent phosphor strips thereof.

### FIELD OF THE INVENTION

The present invention relates to anode structures for field emission displays, and more particularly, to a field emission display with high vacuum degree.

### DESCRIPTION OF RELATED ART

Field emission displays (FEDs) are a new, rapidly developing area of flat panel display technology. Compared to conventional technologies, e.g. cathode-ray tube (CRT) and liquid crystal display (LCD) technologies, FEDs are superior in having a wider viewing angle, low energy consumption, a smaller size and a higher quality display.

FEDs are based on emission of electrons in a vacuum from microscopically-sized tip in a strong electric field, which are then accelerated, and collide with a fluorescent material which is thus excited to emit light. FEDs must be maintained in a high vacuum state so that electrons are moved without energy loss.

One problem with FEDs is that internal components continuously outgas, which causes the performance of FEDs to degrade over time. The effects of outgassing are minimized by using a gas-absorbing material (commonly called getter) within the sealed vacuum chamber of FEDs.

Referring to FIG. 7, a typical FED includes a front plate 10 and a rear plate 20 that are spaced from one another by a gap. An anode electrode 12 and a cathode electrode 22 are formed on the opposite inner surfaces of the front plate 10 and the rear plate 20, respectively. A plurality of gate insulating layers 24 are formed on the cathode electrode 22, and a plurality of gate electrodes 26 are formed on the gate insulating layers 24. A plurality of electron emission sources 28 such as micro tip and carbon nanotube, are formed on the cathode 22. A plurality of spacers 18 for maintaining the gap between the front plate 10 and the rear plate 20 are positioned between the front plate 10 and the back plate 20. A phosphor layer 14 having colors corresponding to pixels are coated on the anode electrode 12, and a black matrix 16 for improving contrast and color purity is formed among the phosphor layer 14. A sealing frame 30 for sealing a display panel is positioned at edges between the front plate 10 and the rear plate 20.

An exhausting path 40 for exhausting an internal gas is formed at one side of the rear plate 20, and a sealing cap 40a for sealing the outlet of the exhausting path 40 is formed at the outlet of the exhausting path 40. A gas path 42 through which the internal gas is flowed into, is positioned at another side of the rear plate 20. A getter container 46 including a getter 44 for absorbing gases is connected to the end of the gas path 42.

In the conventional FED, the getter container 46 protrudes outwardly from the rear plate 20, so that it increases the total thickness of the FED including the getter container 46. Further, since the absorption of the gas is made through the gas path 42 having a narrow section area with very large gas flow resistance, the effective absorption of the gas is difficult. Accordingly, the internal gas cannot be effectively removed, and as a result there is a limited internal vacuum level.

What is needed, therefore, is a field emission display with high internal vacuum degree.

### SUMMARY OF THE INVENTION

An anode structure for a field emission display according to one preferred embodiment includes a front substrate, an anode electrode formed on the front substrate, a phosphor layer formed on the anode electrode and a getter material. The phosphor layer has a plurality of separated phosphor strips each configured for emitting light of a respective single color. The getter material is arranged between two adjacent phosphor strips thereof.

A field emission display according to another preferred embodiment includes a cathode structure having a cathode electrode and an anode structure positioned opposite to the cathode structure. The anode structure includes a front substrate, an anode electrode formed on the front substrate, a phosphor layer formed on the anode electrode and getter material. The phosphor layer has a plurality of separated phosphor strips each configured for emitting light of a respective single color. The getter material is arranged between two adjacent phosphor strips thereof.

The present anode structure for the field emission display uses the getter material arranged between two adjacent phosphor strips thereof, so that the internal gas in the field emission display can be effectively removed and the field emission display is maintained in a high vacuum degree.

Other advantages and novel features will become more apparent from the following detailed description of the present anode structure, when taken in conjunction with the accompanying drawings.

### BRIEF DESCRIPTION OF THE DRAWINGS

Many aspects of the present anode structure for the field emission display can be better understood with reference to the following drawings. The components in the drawings are not necessarily drawn to scale, the emphasis instead being placed upon clearly illustrating the principles of the present anode structure. Moreover, in the drawings, like reference numerals designate corresponding parts throughout the several views.

FIG. 1 is a schematic, cross-sectional view of an anode structure for a field emission display in accordance with a first preferred embodiment;

FIG. 2 is a schematic, cross-sectional view of a field emission display with the anode structure of FIG. 1;

FIG. 3 is a schematic, cross-sectional view of an anode structure for a field emission display in accordance with a second preferred embodiment;

FIG. 4 is a schematic, cross-sectional view of a field emission display with the anode structure of FIG. 3;

FIG. 5 is a schematic, cross-sectional view of an anode structure for a field emission display in accordance with a third preferred embodiment;

FIG. 6 is a schematic, cross-sectional view of a field emission display with the anode structure of FIG. 5; and

FIG. 7 is a schematic, cross-sectional view of a conventional field emission display.

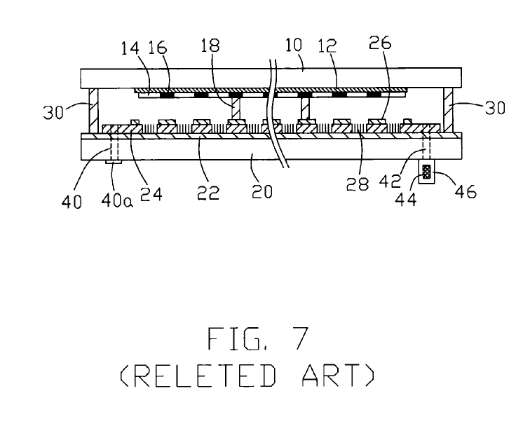

### DETAILED DESCRIPTION OF THE INVENTION

Reference will now be made to the drawings to describe a preferred embodiment of the present field emission display with high internal vacuum state in detail.

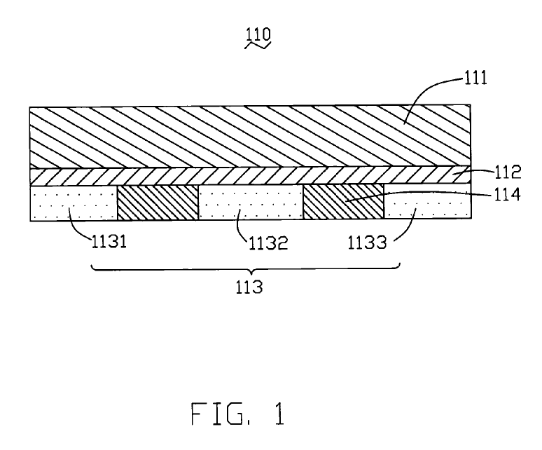

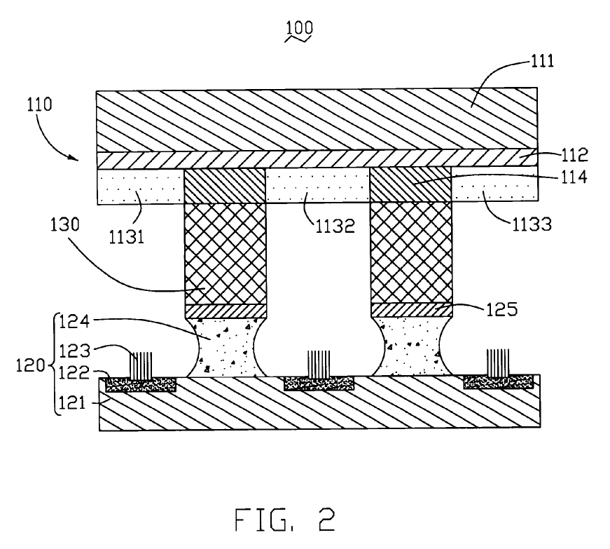

Referring to FIGS. 1 and 2, a field emission display 100 in accordance with a first preferred embodiment is shown. The field emission display 100 mainly includes an anode structure 110, an opposing cathode structure 120 and a plurality of spacers 130 formed between the anode structure 110 and the cathode structure 120 for maintaining a gap between the anode structure 110 and the cathode structure 120.

The anode structure 110 includes a front substrate 111, an anode electrode 112 formed on the front substrate 111, a phosphor layer 113 formed on the anode electrode 112 and a getter material 114. The phosphor layer 113 has a plurality of separated phosphor strips 1131, 1132, 1133 etc. The getter material 114 is arranged between the adjacent phosphor strips thereof.

The front substrate 111 is a flat plate made of an insulating transparent material, such as glass. The anode electrode 112 is made of a transparent conductive material, such as indium tin oxide (ITO). The phosphor layer 113 is formed on the anode electrode 112, and the phosphor layer is composed of a plurality of separated phosphor strips 1131, 1132, 1133 etc. Each separated phosphor strip is configured for emitting light of a respective single color. The separated phosphor strips are arranged in series. A pixel of the field emission display 100 includes three separated phosphor strips 1131, 1132, 1133, which can emit red light, green light and blue light, respectively.

The anode structure 110 further includes a black matrix 114. The black matrix 114 defines a plurality of openings with the phosphor strips 1131, 1132, 1133 arranged at the openings. In this preferred embodiment, the black matrix 114 is made of black non-evaporable getter material. That is, the getter material is incorporated into the black matrix 114 so that the black matrix 114 can be used as a getter material for removing the internal gas produced in the field emission display and can be also used as a black matrix for improving contrast and color purity. The getter material 114 can be made of a black non-evaporable getter material selected from a group consisted of titanium (Ti), zirconium (Zr), hafnium (Hf), thorium (Th), thulium (Tm) and their alloys.

The cathode structure 120 includes a rear substrate 121, a plurality of cathode electrodes 122 formed on the rear substrate 121, a plurality of electron emission source 123, an insulating layer 124 and a plurality of gate electrode 125. The plurality of electron emission source 123 are formed on the corresponding cathode electrode 122, respectively. A plurality of gate electrodes 125 are formed on the insulating layer 124.

In operation, the electron emission source 123 emits electrons, and then the electrons are accelerated by a electric field between the cathode electrode 122 and the gate electrode 125. The electrons are further accelerated by an electric field between the gate electrode 125 and the anode electrode 112 and collide with the phosphor layer 113, which is thus exited to emit light.

Compared with conventional field emission display, the present field emission display 100 has following advantages. The present field emission display 100 uses a getter material 114 incorporated into the black matrix for removing internal gas produced in the field emission display 100. That is, the getter material 114 is arranged in each pixel of the field emission display 100, so that the internal gas in the field emission display 100 can be effectively removed and the field emission display 100 is maintained in a high vacuum state. Furthermore, the getter material 114 is incorporated into the black matrix, so that the present field emission display has a simply structure without any requiring any additional manufacturing in the assembly of the field emission display.

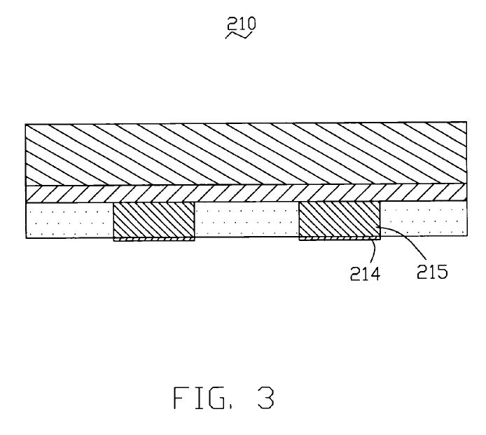

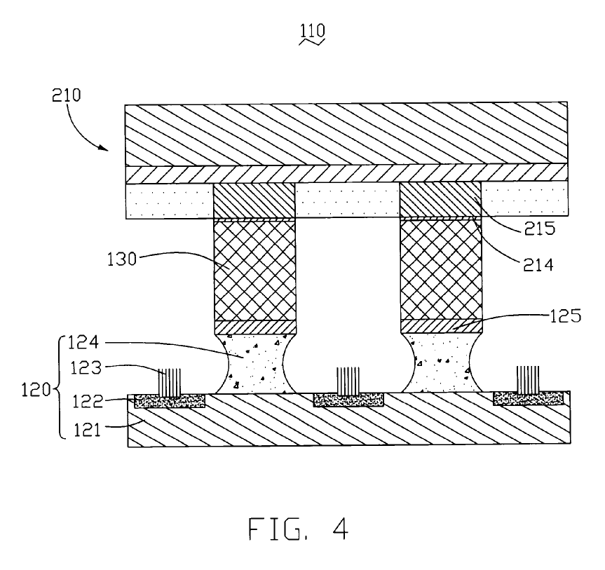

Referring to FIGS. 3 and 4, a field emission display 200 in accordance with a second preferred embodiment is shown. The field emission display 200 in accordance with the second preferred embodiment is similar to the first embodiment, except that the anode structure 210 includes a getter material 214 and a black matrix 215, and the getter material 214 is formed on the black matrix 215. The black matrix 215 is made of common black material the same as conventional black matrix. The getter material 214 is made of non-evaporable getter material, such as Ti, Zr, Hf, Th, Tm or their alloys. The getter material may include a first portion incorporated into the black matrix 215, and a second portion 214 formed on the black matrix. That is, the black matrix 215 is made of black non-evaporable getter material.

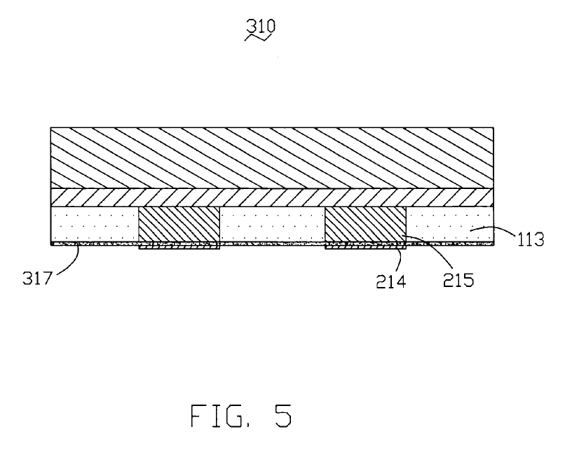

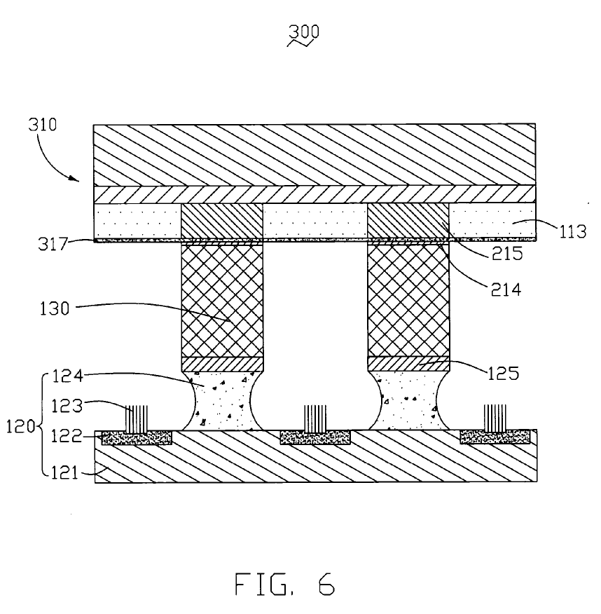

Referring to FIGS. 5 and 6, a field emission display 300 in accordance with a third preferred embodiment is shown. The field emission display 300 in accordance with the third preferred embodiment is similar to the second embodiment, except that in the anode structure 310, an aluminium layer 317 is formed on the black matrix 215 and the phosphor layer 113 for preventing the deterioration of the phosphor layer 113. The getter material 214 is arranged on portions of aluminium layer 317 which cover the black matrix 215. The black matrix 215 is made of common black material the same as a conventional black matrix. The getter material 214 can be made of non-evaporable getter material, such as Ti, Zr, Hf, Th, Tm or their alloys. The black matrix 215 may also be made of a black non-evaporable material, that is, the getter material includes a first portion incorporated into the black matrix 215, and a second portion 214 arranged on portions of the aluminium layer 317 which cover the black matrix 215.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. An anode structure for a field emission display, comprising:
a front substrate;
an anode electrode formed on the front substrate;
a phosphor layer formed on the anode electrode, the phosphor layer having a plurality of separated phosphor strips each configured for emitting light of a respective color; and
a getter material arranged between two adjacent phosphor strips thereof.

2. The anode structure as claimed in claim 1, further comprising a black matrix formed on the anode electrode, the black matrix defines a plurality of openings with the phosphor strips arranged at the openings.

3. The anode structure as claimed in claim 2, wherein the getter material is incorporated into the black matrix.

4. The anode structure as claimed in claim 2, wherein the getter material is formed on the black matrix.

5. The anode structure as claimed in claim 2, further comprising an aluminium layer formed on the black matrix and the phosphor layer, the getter material being arranged on portions of aluminium layer which cover the black matrix.

6. The anode structure as claimed in claim 2, wherein the getter material comprises a first portion incorporated into the black matrix, and a second portion formed on the black matrix.

7. The anode structure as claimed in claim 2, further comprising an aluminium layer formed on the black matrix and the phosphor layer, and the getter material comprising a first portion incorporated into the black matrix, and a second portion arranged on portions of the aluminium layer which cover the black matrix.

8. The anode structure as claimed in claim 1, wherein the getter material is comprised of non-evaporable getter material.

9. The anode structure as claimed in claim 8, wherein the getter material is made of a material selected from a group consisting of titanium, zirconium, hafnium, thorium, thulium and any combination alloy thereof.

10. A field emission display, comprising:
a cathode structure having a cathode electrode; and
an anode structure opposite to the cathode structure, the anode structure comprising a front substrate;
an anode electrode formed on the front substrate;
a phosphor layer formed on the anode electrode, the phosphor layer having a plurality of separated phosphor strips each configured for emitting light of a respective single color; and
a getter material arranged between two adjacent phosphor strips thereof.

11. The field emission display as claimed in claim 10, wherein the anode structure further comprises a black matrix formed on the anode electrode, the black matrix defines a plurality of openings with the phosphor strips arranged in the openings.

12. The field emission display as claimed in claim 11, wherein the getter material is incorporated into the black matrix.

13. The field emission display as claimed in claim 11, wherein the getter material is formed on the black matrix.

14. The field emission display as claimed in claim 11, wherein the anode structure further comprises an aluminium layer formed on the black matrix and the phosphor layer, the getter material being arranged on portions of aluminium layer which cover the black matrix.

15. The field emission display as claimed in claim 11, wherein the getter material comprises a first portion incorporated into the black matrix, and a second portion formed on the black matrix.

16. The field emission display as claimed in claim 11, wherein the anode structure further comprises an aluminium layer formed on the black matrix and the phosphor layer, and the getter material comprising a first portion incorporated into the black matrix, and a second portion arranged on portions of the aluminium layer which cover the black matrix.

17. The field emission display as claimed in claim 10, wherein the getter material is comprised of non-evaporable getter material.

18. The field emission display as claimed in claim 17, wherein the getter material is made of a material selected from a group consisting of titanium, zirconium, hafnium, thorium, thulium and any combination alloy thereof.
